(19) United States
(12) Patent Application Publication
(10) Pub. No.: US 2021/0116676 A1
(43) Pub. Date: Apr. 22, 2021

(54) SYSTEM AND METHOD

(71) Applicant: KABUSHIKI KAISHA TOSHIBA, Tokyo (JP)

(72) Inventors: Hidenori OKUNI, Yokohama Kanagawa (JP); Kentaro YOSHIOKA, Kawasaki Kanagawa (JP); Tetsuro ITAKURA, Nerima Tokyo (JP)

(73) Assignee: KABUSHIKI KAISHA TOSHIBA, Tokyo (JP)

(21) Appl. No.: 17/019,874

(22) Filed: Sep. 14, 2020

(30) Foreign Application Priority Data
Oct. 16, 2019 (JP) 2019-189631

(51) Int. Cl. G02B 7/182; G01S 17/42; G01S 17/89

(52) U.S. Cl. CPC G02B 7/182; G01S 17/89; G01S 17/42

(57) ABSTRACT

A system has receiver circuitry configured to receive mirror information including at least one of a position, size, height, or an angle of the mirror and surrounding information acquired by measurement of at least part of surrounding of the mirror, and processing circuitry configured to specify a first range observable via a reflection in the mirror, estimate, based on the surrounding information, a second range observable via a reflection in the mirror whose at least one of the position, size, height, or angle is changed, and generate adjustment information used to adjust at least one of the position, height, or angle of the mirror in accordance with the first range information and the second range information.

### CROSS REFERENCE TO RELATED APPLICATIONS

This application is based upon and claims the benefit of priority from the prior Japanese Patent Application No. 2019-189631, filed on Oct. 16, 2019, the entire contents of which are incorporated herein by reference.

### FIELD

An embodiment of the present invention relates to a system and a method.

### BACKGROUND

Curved mirrors installed on the side of roads and other places display a blind spot area to the driver of a vehicle and thus play an important role in preventing accidents. In recent years, more curved mirrors are installed in shops and other facilities for security purposes.

A range of reflection that can be emitted by the curved mirror changes depending on the position, height, and angle of the curve mirror, and the angle of the curved mirror is adjusted during installation to optimize the angle of the mirror. However, the angle of the curved mirror may change after the installation due to wind or contact with the mirror, causing a possibility of failure in emitting the intended range.

### BRIEF DESCRIPTION OF THE DRAWINGS

FIG. 1 is a block diagram illustrating a schematic configuration of a system according to a first embodiment;

FIG. 2 is a flowchart illustrating an example of a processing operation of the system of FIG. 1;

FIG. 3 illustrates an example of surrounding information acquired by an acquisition unit;

FIG. 4 illustrates an example of a first range;

FIG. 5 illustrates, in bold lines, the first range information reflected in the mirror before adjustment among surrounding information acquired by the acquisition unit;

FIG. 6 illustrates an example of information in a second range;

FIG. 7 illustrates information reflected in the mirror after the angle and the like of the mirror are adjusted in accordance with adjustment information;

FIG. 8 illustrates the range reflected in the mirror in bold lines;

FIG. 9 is a block diagram of a system 1a according to a first modification including a mirror having an automatic adjustment function;

FIG. 10 is a block diagram of a system according to a second modification;

FIG. 11 is a block diagram of a system according to a third modification;

FIG. 12 is a block diagram illustrating a schematic configuration of a system according to a second embodiment;

FIG. 13 illustrates an example in which the second range is divided into a plurality of areas and each area is digitized;

FIG. 14 illustrates the score of the mirror reflection of FIG. 7; and

FIG. 15 illustrates the score of the mirror reflection of FIG. 4.

### DETAILED DESCRIPTION

According to one embodiment, a system has receiver circuitry configured to receive mirror information including at least one of a position, size, height, or an angle of the mirror and surrounding information acquired by measurement of at least part of surrounding of the mirror, and processing circuitry configured to specify a first range observable via a reflection in the mirror, estimate, based on the surrounding information, a second range observable via a reflection in the mirror whose at least one of the position, size, height, or angle is changed, and generate adjustment information used to adjust at least one of the position, height, or angle of the mirror in accordance with the first range information and the second range information.

Embodiments of the system and the method will be described below with reference to the accompanying drawings. Although the following description will focus on the major constituent components of the system, there may be constituent components and functions in the system that are not illustrated or described.

### First Embodiment

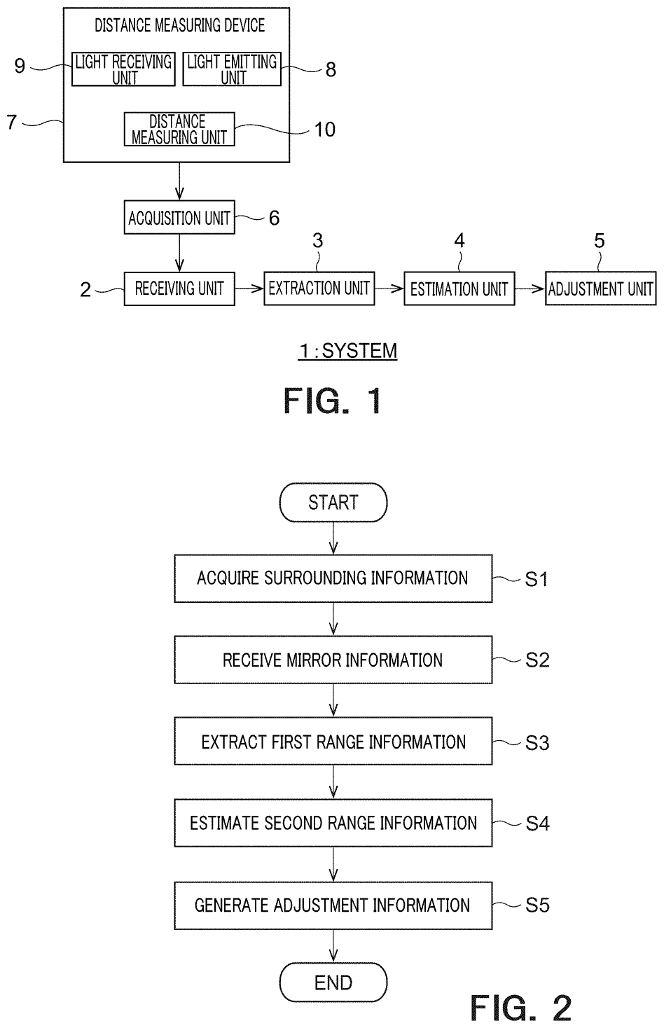

FIG. 1 is a block diagram illustrating a schematic configuration of a system 1 according to a first embodiment. The system 1 in FIG. 1 includes a mirror adjustment function. The system 1 of FIG. 1 may be installed in a vehicle or an electronic device carried by a worker who maintains and manages a mirror. Further, at least a part of the processing executed by the system 1 of FIG. 1 may be executed by an information processing device such as a server (not illustrated) connected to the network.

The system 1 of FIG. 1 includes a receiving unit 2, an extraction unit 3, an estimation unit 4, and an adjustment unit 5. In addition, an acquisition unit 6 is connected to the system 1 of FIG. 1. The acquisition unit 6 may be provided inside the system 1 in FIG. 1 or outside the system 1 in FIG. 1.

The acquisition unit 6 acquires surrounding information. Here, the surrounding information is information on any object existing around the acquisition unit 6, and also includes information on a mirror. The object refers to a concept that includes living things such as humans as well as structures and moving objects. The acquisition unit 6 may acquire the surrounding information by any method. For example, the acquisition unit 6 may acquire the surrounding information by transmitting electromagnetic waves such as light to the surroundings and receiving reflected waves of the electromagnetic waves reflected by a surrounding object. Alternatively, the acquisition unit 6 may acquire the surrounding information in accordance with a photographed surrounding image which will be described later.

In the example of FIG. 1, the acquisition unit 6 acquires the surrounding information using a distance measuring device 7. The distance measuring device 7 is also called a light detection and ranging (LiDAR) device. The distance measuring device 7 includes a light emitting unit 8, a light receiving unit 9, and a distance measuring unit 10. The light emitting unit 8 emits, for example, laser light in a predetermined frequency band. Laser light is coherent light with its phase and frequency being aligned. The light emitting unit 8 intermittently emits pulsed laser light at a predetermined cycle. The cycle in which the light emitting unit 8 emits the laser light is a time interval equal to or longer than the time required for the distance measuring device 7 to measure the distance for each pulse of the laser light.

More specifically, the light receiving unit 9 has a photodetector, an amplifier, a light receiving sensor, an analog-to-digital (A/D) converter, and the like, which are not illustrated. The photodetector receives part of emitted laser light and converts it into an electric signal. The amplifier amplifies the electric signal output from the photodetector. The light receiving sensor converts the received laser light into an electric signal. The A/D converter converts the electric signal output from the light receiving sensor into a digital signal.

The distance measuring unit 10 measures the distance to the point where the received electromagnetic wave is reflected, in accordance with a time difference between the transmission timing of the transmitted electromagnetic wave and the reception timing of the received electromagnetic wave. When the laser beam is used as the electromagnetic wave, the distance measuring unit 10 measures the distance in accordance with

Distance=Speed of Light×(reception timing of reflected light−transmission timing of reflected light)/2 (1)

Since the distance measuring unit 10 measures the distances to various objects existing around the distance measuring device 7, a depth map can be generated in accordance with the measured distance to each object. The acquisition unit 6 can acquire the surrounding information from the depth map.

Note that, in FIG. 1, an example in which the acquisition unit 6 acquires the surrounding information using the distance measuring device 7 is illustrated, but the acquisition unit 6 may use a device, a sensor, or the like, other than the distance measuring device 7 to acquire the surrounding information. The acquisition unit 6 may be installed, for example, in a vehicle. The acquisition unit 6 may acquire the surrounding information in accordance with the depth map that is based on the distance measured by the distance measuring unit 10. In a case where a photographing unit that photographs the surroundings is provided as will be described later, the acquisition unit 6 may acquire the surrounding information in accordance with the image photographed by the photographing unit.

The receiving unit 2 receives the mirror information including at least one of the position, size, height, or angle of the mirror included in the surrounding information. More specifically, the receiving unit 2 receives the mirror information included in the surrounding information acquired by the acquisition unit 6. Here, the mirrors include not only curved mirrors but also various other members that provide specular reflection (regular reflection), and any shape and size of mirrors can be used. Any purpose may be used for installing the mirror. For example, the mirror may be installed to reflect blind spot areas for the driver of the vehicle, to allow the security camera to photograph blind spot areas for the security camera, or for any other purpose. The mirror may also be installed at any location outdoors or indoors.

The extraction unit 3 specifies the information of a first range reflected in the mirror. More specifically, the extraction unit 3 specifies information of the first range reflected in the mirror in accordance with the surrounding information acquired by the acquisition unit 6 and the mirror information received by the receiving unit 2. The first range is a range considered to be actually reflected in the mirror before the angle of the mirror is adjusted. The extraction unit 3 specifies the first range reflected in the mirror by calculation processing in accordance with the surrounding information and the mirror information. If the position, size, height, and angle of the mirror are known, the range of reflection in the mirror can be extracted from the surrounding information by calculation processing.

The estimation unit 4 estimates, based on the surrounding information, a second range observable via a reflection in the mirror whose at least one of the position, size, height, or angle is changed. For example, the range of reflection in the mirror can be changed by simply changing the height or angle of the mirror. Therefore, when the mirror information such as the height and angle of the mirror is changed, the estimation unit 4 estimates the range of reflection in the mirror and sets this range as a second range.

Alternatively, the estimation unit 4 may estimate the information of the second range in accordance with geographic information read from the storage unit that stores the geographic information. Here, the geographic information refers to various kinds of information regarding an object reflected in the mirror, such as map information, topographic information, road information, shop information, obstacle information, and the like. The geographic information stored in a storage unit may be updated regularly or irregularly.

In estimating the second range information by the estimation unit 4, detection information of the sensor (e.g., an image sensor) used when the acquisition unit 6 acquires the surrounding information may be used.

The adjustment unit 5 generates adjustment information used to adjust at least one of the position, height, or angle of the mirror in accordance with the first and second range information. For example, if there is any object in the second range estimated by the estimation unit 4, although not reflected in the mirror before adjustment, the adjustment unit 5 changes the adjustment information to reflect the object in the mirror.

The adjustment unit 5 may generate the final adjustment information by averaging the adjustment information generated continuously or intermittently. If the surrounding information acquired by the acquisition unit 6 may include an error, the influence of the error can be reduced by averaging the adjustment information.

The adjustment unit 5 may generate the adjustment information in accordance with the installation information including at least one of the location, direction, height, or angle of the installation of the distance measuring device 7, and the first and second range information.

As will be described later, in a case where the photographing unit for photographing the surroundings is provided, the adjustment unit 5 may generate the adjustment information in accordance with the installation information including at least one of the location, direction, height, or angle of the installation of the distance measuring device, and the first and second range information.

The system 1 of FIG. 1 may transmit the adjustment information to another electronic device or the like via, for example, a network or the like. Alternatively, the system 1 of FIG. 1 may display the adjustment information on a display unit (not illustrated). Alternatively, the system 1 of FIG. 1 may store the adjustment information in a storage device (not illustrated).

For example, when the system 1 of FIG. 1 transmits the adjustment information to an electronic device carried by a worker who performs maintenance of the mirror, the worker can confirm the adjustment information on the display unit of the electronic device. Then, according to the confirmed adjustment information, the height and angle of the mirror are manually adjusted. This makes it possible to optimize the height and angle of the mirror.

FIG. 2 is a flowchart illustrating an example of the processing operation of the system 1 of FIG. 1. For example, the system 1 of FIG. 1 may automatically start the processing of the flowchart of FIG. 2 when the power of the system 1 is turned on. Alternatively, the processing of the flowchart of FIG. 2 may be started when the user selects the mirror adjustment processing from a screen menu displayed on the display unit after the power of the system 1 is turned on. Alternatively, the processing of the flowchart of FIG. 2 may be started when the user operates a button or the like provided in the system 1 of FIG. 1.

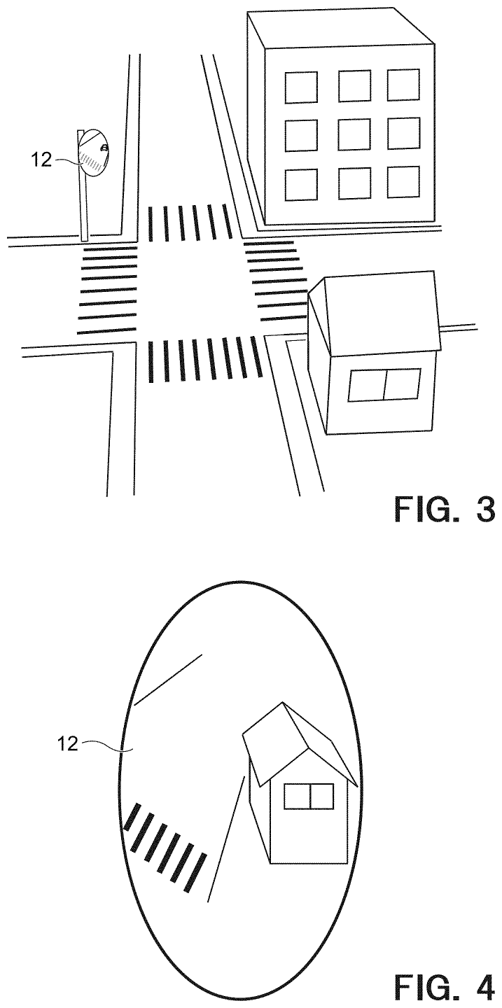

First, the acquisition unit 6 acquires surrounding information (step S1). FIG. 3 illustrates an example of the surrounding information acquired by the acquisition unit 6. In the example of FIG. 3, the acquisition unit 6 exists on the front side, and the acquisition unit 6 acquires the surrounding information from the front side to the back side.

The acquisition unit 6 may acquire the surrounding information at any timing. For example, when the acquisition unit 6 is installed in a moving object such as a vehicle, the surrounding information may be acquired at the timing when the moving object is stopped or temporarily stopped. Alternatively, the surrounding information may be repeatedly acquired at predetermined time intervals.

Next, the receiving unit 2 receives the mirror information including at least one of the position, size, height, or angle of the mirror 12 included in the surrounding information acquired by the acquisition unit 6 (step S2). When the acquisition unit 6 acquires the surrounding information using the distance measuring device 7, the receiving unit 2 may receive the mirror information from the depth map output from the distance measuring device 7. More specifically, the receiving unit 2 may receive the position, height, angle, and the like of the mirror by performing shape extraction processing from the points constituting the depth map.

Next, the extraction unit 3 specifies the first range information considered to be reflected in the mirror 12 before adjustment in accordance with the surrounding information and the mirror information (step S3). As described above, the extraction unit 3 performs calculation processing in accordance with the height, angle, and the like of the mirror 12 to specify the first range, which is considered to be reflected on the mirror 12, from the surrounding information.

FIG. 4 illustrates an example of the first range. The mirror 12 included in the surrounding information in FIG. 3 is oriented to the right, so that the first range information around the right-hand side road is reflected in the mirror 12. Since the angle of the mirror 12 in the example of FIG. 4 is not appropriate, only a part of the road extending to the right is reflected in the mirror 12. In addition, the mirror 12 partly reflects a building near the intersection, although the building does not need to be reflected essentially.

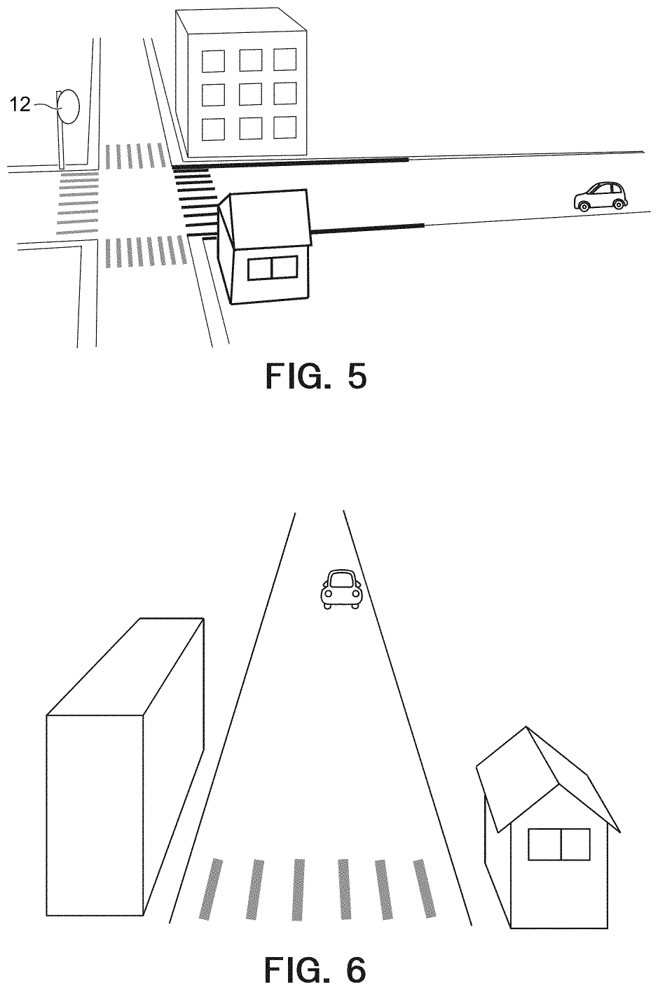

In FIG. 5, among the surrounding information acquired by the acquisition unit 6, the first range information reflected in the mirror 12 before adjustment is represented in bold lines. Since the mirror 12 only reflects a part of the road extending to the right before adjustment, the presence of a vehicle coming from the right side of the road toward the intersection cannot be known from the information of the mirror 12.

Next, the estimation unit 4 estimates, in accordance with the surrounding information, the second range information that is possibly reflected in the mirror 12 when the mirror information is changed (step S4). The second range information is information of a range that can be reflected in the mirror 12 when the mirror information such as the height and the angle of the mirror 12 is changed.

FIG. 6 illustrates an example of information in the second range. FIG. 6 illustrates the range that can be reflected in the mirror 12 from the position of the mirror 12 in FIG. 3 when the height, angle, or the like of the mirror 12 is changed. As can be seen by comparing FIGS. 5 and 6, the second range information includes a vehicle coming toward the intersection on the road extending on the right-hand side of the intersection, and this vehicle should be able to be reflected in the mirror 12.

Therefore, the adjustment unit 5 generates adjustment information for adjusting at least one of the position, height, or angle of the mirror 12 in accordance with the information of the first and second range information (step S5). The generated adjustment information may be displayed on, for example, a display unit of the electronic device carried by the worker who maintains and manages the mirror 12, and the worker may manually adjust the mirror 12 according to the display. Alternatively, the mirror 12 may be automatically adjusted.

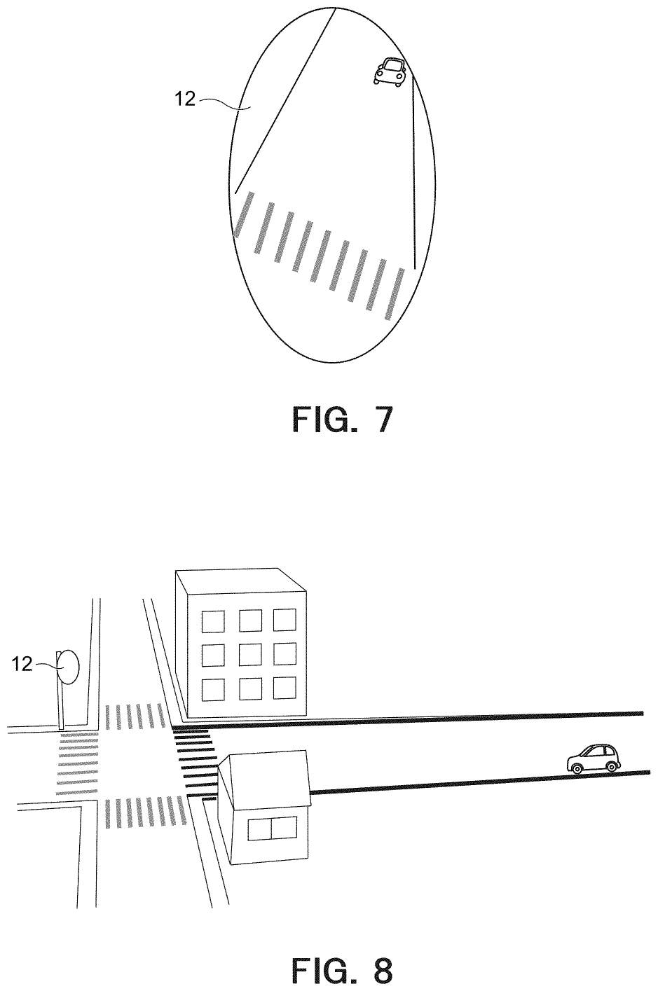

FIG. 7 illustrates the information reflected in the mirror 12 after the angle and the like of the mirror 12 are adjusted in accordance with the adjustment information, and FIG. 8 illustrates the range reflected in the mirror 12 in bold lines. As illustrated in FIG. 7, since the vehicle traveling toward the intersection on the road extending on the right-hand side of the intersection is reflected, it can be seen that the blind spot portion of the mirror 12 has been reduced. Further, as can be seen by comparing FIGS. 8 and 5, the information on a substantially wider range than that of FIG. 5 of the road is reflected in the mirror 12.

As described above, simply adjusting the height and angle of the mirror 12 can increase the amount of necessary information to be reflected in the mirror 12, thus increasing the utility value of the mirror 12.

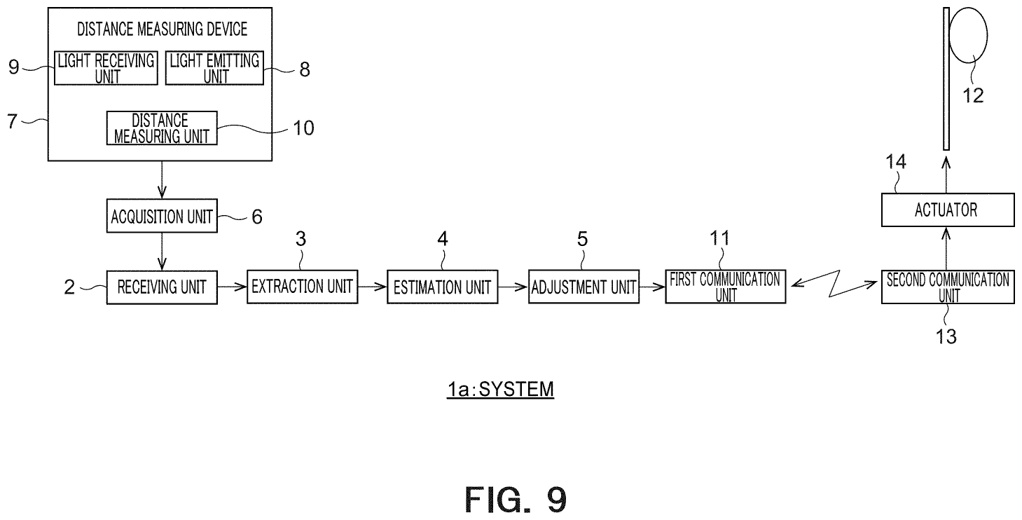

FIG. 9 is a block diagram of a system 1a according to a first modification including a mirror 12 having an automatic adjustment function. The system 1a of FIG. 9 includes, in addition to the configuration of the system 1 of FIG. 1, a first communication unit 11 connected to the adjustment unit 5, and a second communication unit 13 and an actuator 14 which are built in or connected to the mirror 12.

The first communication unit 11 transmits the adjustment signal generated by the adjustment unit 5, for example, wirelessly. The second communication unit 13 receives the adjustment signal wirelessly transmitted by the first communication unit 11. The actuator 14 adjusts the height, angle, and the like of the mirror 12 in accordance with the received adjustment signal. The power supply to drive the second communication unit 13 and the actuator 14 may be supplied from the ground or a wire from a utility pole, or a small solar panel or wind generator may be installed on the mirror 12 to drive the second communication unit 13 and actuator 14 with power generated by itself.

Note that at least one of the receiving unit 2, the extraction unit 3, the estimation unit 4, or the adjustment unit 5 in the system 1 of FIG. 9 may be built in the mirror 12. Further, the receiving unit 2, the extraction unit 3, the estimation unit 4, and the adjustment unit 5 may be provided in an information processing device such as a server connected to the network.

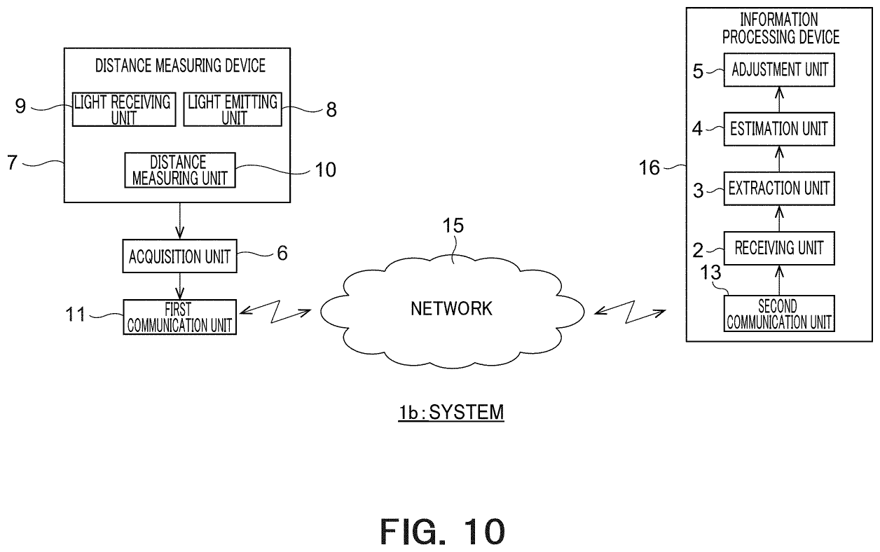

FIG. 10 is a block diagram of a system 1b according to a second modification. In the system 1b of FIG. 10, an information processing device 16 connected to the network 15 generates the adjustment signal. The distance measuring device 7 of FIG. 10 includes a first communication unit 11 in addition to the configuration of FIG. 1. The first communication unit 11 transmits the surrounding information acquired by the acquisition unit 6 using the distance measuring device 7 or the like to the network 15 by wire or wirelessly. The distance measuring device 7, the acquisition unit 6, and the first communication unit 11 are installed in, for example, a vehicle.

The information processing device 16 is, for example, a server connected to the network 15. The information processing device 16 includes the second communication unit 13, the receiving unit 2, the extraction unit 3, the estimation unit 4, and the adjustment unit 5, and, in accordance with the surrounding information received by the second communication unit 13 via the network 15, sequentially performs the processing of the receiving unit 2, the extraction unit 3, the estimation unit 4, and the adjustment unit 5, as described above, to generate the adjustment signal. The generated adjustment signal is transmitted, via the second communication unit 13 or another communication unit, to, for example, the electronic device carried by the operator who performs maintenance of the mirror 12 or a mirror having a communication function and an actuator function.

In the system 1, 1a, or 1b of FIG. 1, 9, or 10 described above, the example in which the acquisition unit 6 acquires the surrounding information using the distance measuring device 7 has been described, but the acquisition unit 6 may use the photographing unit to acquire the surrounding information.

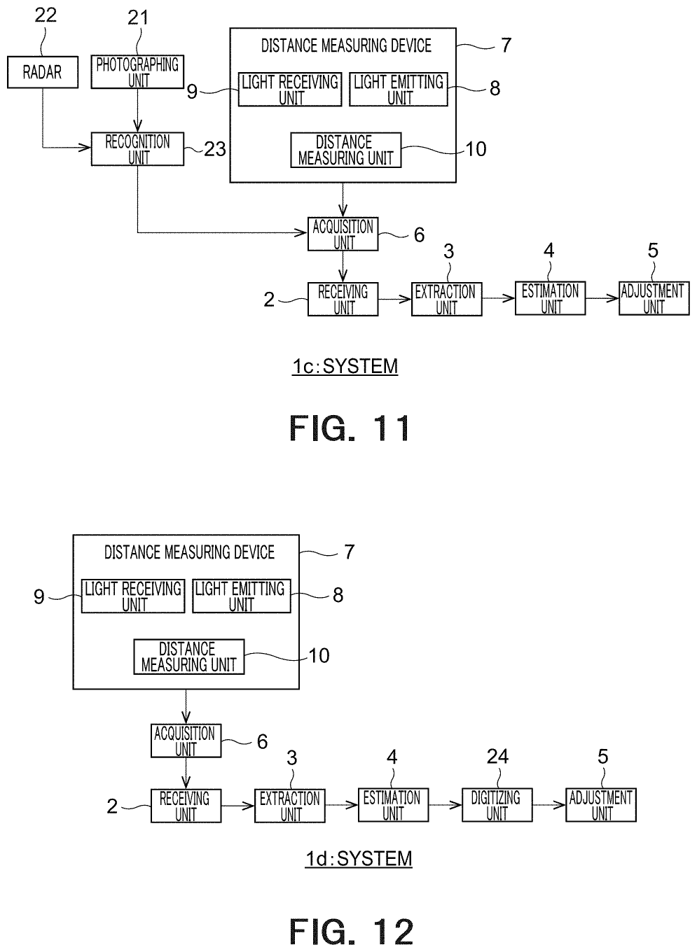

FIG. 11 is a block diagram of a system 1c according to a third modification. In addition to the distance measuring device 7, the system 1c of FIG. 11 includes at least one of the photographing unit 21 or the radar 22, and a recognition unit 23. One of the photographing unit 21 or the radar 22 needs to be included, but not necessarily both are included.

The photographing unit 21 photographs the surroundings of the photographing unit 21. The photographing unit 21 may be, for example, an image sensor or a camera. The radar 22 transmits an electromagnetic wave in a specific frequency band and receives the reflected wave. The electromagnetic waves transmitted by the radar 22 may be millimeter waves.

The recognition unit 23 specifies the position of the mirror 12 using a method such as pattern matching in accordance with at least one of the image photographed by the photographing unit 21 or the image that is based on the received signal from the radar 22. The acquisition unit 6 may acquire the surrounding information in accordance with the measurement result of the distance measuring device 7 and the recognition result of the recognition unit 23.

In the system 1c of FIG. 11, the example is illustrated in which, in addition to the distance measuring device 7, at least one of the photographing unit 21 or the radar 22 is used to acquire the surrounding information. Alternatively, the surrounding information may be acquired using at least one of the photographing unit 21 or the radar 22 without using the distance measuring device 7.

As described above, in the first embodiment, the first range information reflected in the mirror 12 is specified by receiving the information of the mirror 12, such as the position and height of the mirror 12, from the surrounding information acquired by the acquisition unit 6. When the information of the mirror 12 is changed, the second range information that can be reflected in the mirror 12 is estimated and the adjustment information for adjusting the height, angle, and the like of the mirror 12 is generated from the first and second range information. This facilitates optimization of the height, angle, and the like of the mirror 12 when the height, angle, and the like of the mirror 12 are not desirable. Therefore, the blind spot of the mirror 12 can be reduced, and the utility value of the mirror 12 can be increased.

### Second Embodiment

A second embodiment digitizes the range of reflection in the mirror 12.

FIG. 12 is a block diagram illustrating a schematic configuration of a system 1d according to the second embodiment. The system 1d of FIG. 12 includes a digitizing unit 24 in addition to the configuration of the system 1 of FIG. 1. The digitizing unit 24 divides the second range into a plurality of areas, digitizes each area, and calculates the sum of the numerical values of the areas included in the range of reflection in the mirror 12. The adjustment unit 5 generates adjustment information in accordance with a summed value calculated by the digitizing unit 24. More specifically, the adjustment unit 5 generates the adjustment information so that the summed value is equal to or larger than the predetermined reference value.

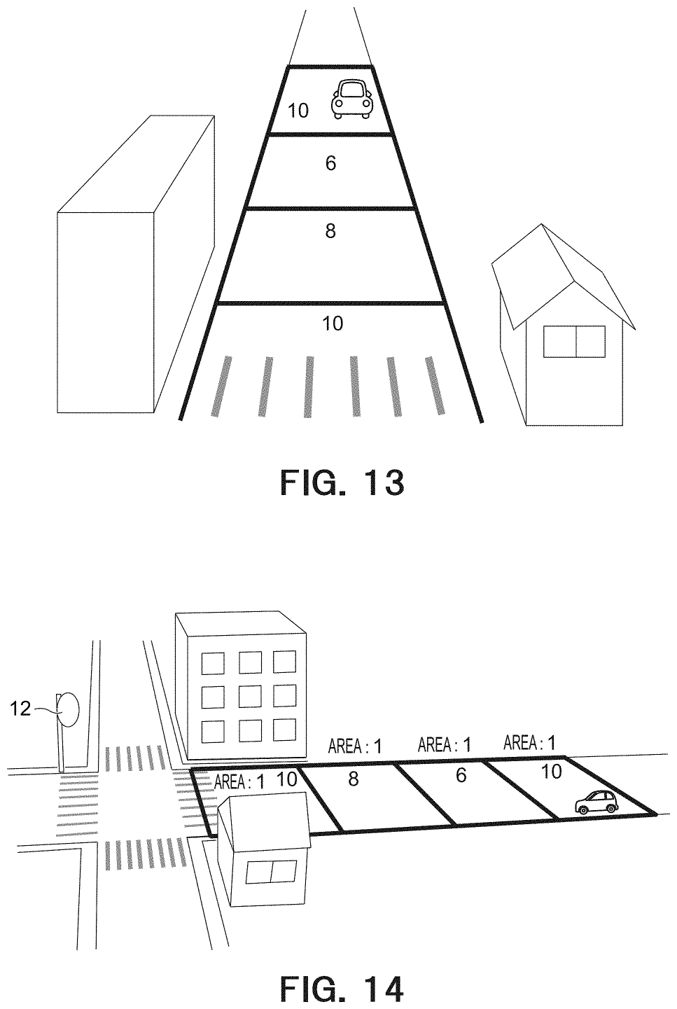

FIG. 13 illustrates an example in which the second range is divided into a plurality of areas and each area is digitized. In the example of FIG. 13, the road extending in the depth direction from the intersection is divided into four areas, and each area is digitized in order from the side nearest the intersection into 10, 8, 6, and 10 points. The fourth area from the intersection is scored as high as 10 points because of the presence of the vehicle in that area.

Note that the extent to which the second range is divided into areas and the number of points in each region can be determined freely. Further, the score may be changed depending on whether the object exists in each area, the score may be different depending on the type of the object, or the score may be set for each area regardless of the presence or absence of the object.

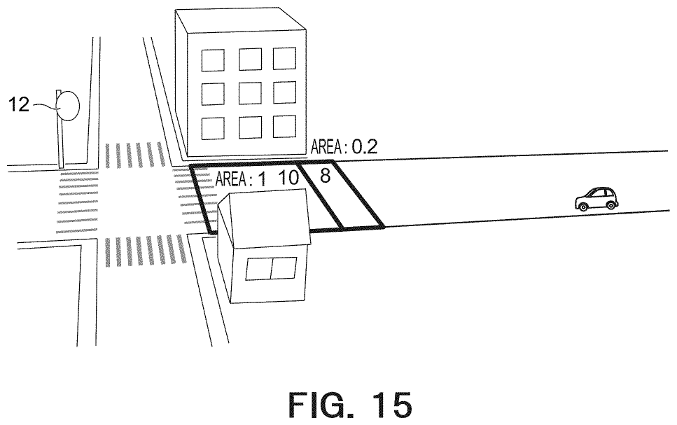

For example, when the range of FIG. 7 is reflected in the mirror 12, four areas are reflected as illustrated in FIG. 14, and the summed value is 10+8+6+10=34 points. On the other hand, when the range of FIG. 4 is reflected on the mirror 12, only two areas are reflected as illustrated in FIG. 15, and the summed value is 10+8=18 points.

The adjustment unit 5 compares the summed value with the reference value, and determines whether the adjustment of the mirror 12 should be performed in accordance with the comparison result. For example, assuming that the reference value is set to 20 points, the adjustment unit 5 determines no need for readjustment of the mirror 12 in the case of FIG. 7, but determines that the adjustment of the mirror 12 is necessary in the case of FIG. 4 and adjusts the height, angle, and the like of the mirror 12 to increase the summed value to exceed 20 points.

As described above, the second embodiment digitizes the reflection range of the mirror 12 to determine whether the height, angle, and the like of the mirror 12 should be adjusted. Therefore, variation in the adjustment of the mirror 12 by, for example, workers who maintain the mirror 12 can be reduced.

The system 1 according to the first and second embodiments is applicable not only to the mirrors 12 such as roadside mirrors and mirrors for security systems as described above, but also to the mirrors 12 for logistics systems, gate systems, and the like.

1. A system, comprising:
receiver circuitry configured to receive mirror information including at least one of a position, size, height, or an angle of the mirror and surrounding information acquired by measurement of at least part of surrounding of the mirror; and
processing circuitry configured to:
specify a first range observable via a reflection in the mirror;
estimate, based on the surrounding information, a second range observable via a reflection in the mirror whose at least one of the position, size, height, or angle is changed; and
generate adjustment information used to adjust at least one of the position, height, or angle of the mirror in accordance with the first range information and the second range information.

2. The system according to claim 1, wherein
the processing circuitry is further configured to specify the first range in accordance with the surrounding information and the mirror information.

3. The system according to claim 1, wherein
the processing circuitry generates the adjustment information in a manner that the mirror reflects at least a part of the information that is absent in the first range but present in the second range.

4. The system according to claim 1, further comprising:
a storage configured to store geographic information, wherein
the processing circuitry estimate the second range information with reference to the geographic information stored in the storage.

5. The system according to claim 1,
wherein the processing circuitry is further configured to acquire the surrounding information from a measurement device.

6. The system according to claim 5, wherein
the processing circuitry is installed in a moving object.

7. The system according to claim 5,
wherein the processing circuitry is further configured to measure a distance to a surrounding object, wherein
the processing circuitry acquire the surrounding information in accordance with the measure distance.

8. The system according to claim 7, further comprising:
a transmitter that transmits an electromagnetic wave in a plurality of transmission directions,
wherein the receiver receives the electromagnetic wave transmitted from the transmitter and reflected by the mirror, wherein
the processing circuitry measure the distance to the surrounding object in accordance with the transmission direction and a transmission timing of the electromagnetic wave transmitted by the transmitter, and a reception timing of the electromagnetic wave received by the receiver, and
the processing circuitry acquire the surrounding information in accordance with a depth map that is in accordance with the measured distance.

9. The system according to claim 7, wherein
the processing circuitry generate the adjustment information in accordance with installation information including at least one of a location, a direction, height, or an angle of installation of the processing circuitry, and the first and second range information.

10. The system according to claim 5, further comprising:
an imager that picks up image including the surrounding information, wherein
the processing circuitry acquire the surrounding information in accordance with the image picked up by the imager.

11. The system according to claim 10, wherein
the processing circuitry generate the adjustment information in accordance with installation information including at least one of a location, a direction, height, or an angle of installation of the imager, and the first and second range information.

12. The system according to claim 1,
wherein the processing circuitry is further configured to divide the second range into a plurality of areas, digitize each area, and calculate a sum of numerical values of the areas included in a reflection range of the mirror, and
the processing circuitry generate the adjustment information in accordance with the calculated numerical value.

13. The system according to claim 1, wherein
the processing circuitry generate final adjustment information by staggering processing time for generating the adjustment information a plurality of times and averaging the adjustment information of the plurality of times of processing.

14. The system according to claim 1, wherein
the processing circuitry is further configured to change at least one of the position, height, or angle of the mirror in accordance with the adjustment information.

15. A system, comprising:
receiver circuitry configured to receive mirror information including at least one of a position, size, height, or an angle of the mirror and surrounding information acquired by measurement of at least part of surrounding of the mirror; and
processing circuitry configure to:
acquire surrounding information;
specify first range observable via a reflection in the mirror in accordance with the surrounding information and the mirror information;
estimate, based on the surrounding information, a second range observable via a reflection in the mirror whose at least one of the position, size, height, or angle is changed; and
generate adjustment information used to adjust at least one of the position, height, or angle of the mirror in accordance with the first and second range information.

16. A method, comprising:
receiving mirror information including at least one of a position, size, height, or an angle of a mirror and surrounding information acquired by measurement of at least part of surrounding of the mirror;
specifying first range observable via a reflection in the mirror;
estimating, based on the surrounding information, a second range observable via a reflection in the mirror at least one of the position, size, height, or angle is changed; and
generating adjustment information used to adjust at least one of the position, height, or angle of the mirror in accordance with the first and second range information.

17. The method according to claim 16, wherein
the first range information reflected in the mirror is specified in accordance with the surrounding information and the mirror information.

18. The method according to claim 16, wherein
the adjustment information is generated in a manner that the mirror reflects at least a part of the information that is absent in the first range but present in the second range.

19. The method according to claim 16, wherein
the second range information is extracted with reference to the geographic information stored in a storage.

20. The method according to claim 16, wherein
wherein the surrounding information is acquired from a measurement device.
